(19) United States
(12) Patent Application Publication
(10) Pub. No.: US 2026/0075076 A1
(43) Pub. Date: Mar. 12, 2026

(54) METHOD AND SYSTEM FOR CYBER RANGE DEVELOPMENT

(71) Applicant: Circadence Corporation, Boulder, CO (US)

(72) Inventor: Bradley Hayes, Boulder, CO (US)

(21) Appl. No.: 19/322,501

(22) Filed: Sep. 8, 2025

Related U.S. Application Data
(60) Provisional application No. 63/692,540, filed on Sep. 9, 2024.
(60) Provisional application No. 63/795,917, filed on Apr. 28, 2025.

(51) Int. Cl. H04L 9/40; H04L 41/16

(52) U.S. Cl. CPC H04L 63/1433; H04L 41/16

(57) ABSTRACT

A cyber range development system and method is configured to receive conversational inputs from a user regarding a desired cyber range, generate a graphical representation of the desired cyber range from the inputs, validate the created range, and export specifications for the created range for use by a range orchestrator in generating the actual range.

### RELATED APPLICATION DATA

This application claims priority to U.S. Provisional Application Ser. No. 63/795,917, filed Apr. 28, 2025, and U.S. Provisional Application Ser. No. 63/692,540, filed Sep. 9, 2024, which prior applications are incorporated by reference herein in their entirety.

### FIELD OF THE INVENTION

The present invention relates to methods and systems for cyber range development.

### BACKGROUND OF THE INVENTION

A cyber range is a virtual environment that is generated by physical computing devices and that is used to implement cyber training scenarios and support evaluation activities. The purpose of a cyber range is to create an environment where participants can safely practice techniques and tools relating to computing devices and systems, such as the latest cyber warfare tools against the latest cyber threats, or to simulate and measure digital effects without any security concerns or ramifications to existing physical operational systems.

One significant problem with cyber ranges arises in their creation. Generally, each cyber range must be individually constructed. This is generally a time consuming, expensive and tedious task, requiring the user to input detailed specifications regarding the desired cyber range, which specifications can then be used by a range creator to generate the cyber range. This process may require the user to know specific protocols, infrastructure details, input formats or the like, for the particular range creator, so as to be able to provide the necessary inputs for creation of the range. Further, the input specifications may not enable a functional cyber range. Thus, after providing input specifications, the range creator might output errors indicating that the range can't be constructed based upon those specifications, or might output a cyber range that is not fully operational. In addition, as a result of the above, it may be difficult and/or time consuming for a user to make corrections in order to render the cyber range operational, or to modify or update a cyber range after it has been created.

While a created cyber range might be used many times, including by different users, it is frequently desirable to custom create a cyber range for a particular training scenario. This requires the user to go through the process noted above each time a new training scenario is desired.

A solution to these and other technical problems associated with the creation of a cyber range is desired.

### SUMMARY OF THE INVENTION

Aspects of the invention comprise methods, devices and systems for cyber range development.

In one embodiment, the invention is configured to receive inputs from a user regarding a desired cyber range, transform those inputs into a graphical representation of the desired cyber range, validate the created range, generate and either export specifications for the created range for use by a range orchestrator in implementing the actual range or deploying it directly, and training a generative model to create a cyber range. The invention is also configured to produce training data for generative model performance improvements.

In one embodiment, a cyber range development system comprises a computing device comprising a processor, a memory, a communication interface, and machine-readable code stored in the memory and executable by the processor to cause the processor to: implement an input engine, the engine configured to receive conversational inputs regarding a cyber range received from a user via a user interface device to the computing device via the communication interface, and to transform the user inputs into cyber range development instructions; implement an interpreter configured to transform the cyber range development instructions into cyber range data; implement a representer, the representer configured to utilize the cyber range data to generate information regarding a graphical representation of the cyber range for use by the user interface device in displaying the graphical representation of the cyber range on a display of the user interface device; implement a validator configured to determine a validity of the graphically represented cyber range; and implement an exporter, the exporter configured to transform the information regarding the graphical representation of the cyber range into a cyber range specification usable by a cyber range orchestrator to deploy the generated cyber range.

The input engine may leverage a large language model, such as including model data stored in an associated database, for interpreting the user inputs. The large language model may utilize an iterative process of providing follow up questions to said user and receiving responses from said user to said follow up questions to determine criteria for said cyber range.

In one embodiment, the invention is embodied in a method for developing a cyber range system including receiving inputs from a user regarding a desired cyber range, transforming those inputs into a graphical representation of the desired cyber range, validating the created range, generating and either exporting specifications for the created range for use by a range orchestrator in implementing the actual range or deploying it directly, and training a generative model to create a cyber range. The method may further include implementing a user interface between said input engine and said user interface device and said representer and said user interface device.

Said information regarding said graphical representation may include information regarding a plurality of nodes and edges. Said graphical representation may include information regarding graphically represented range elements, one or more associated characteristics and specifications of said range elements, and a plurality of interconnected relationships between said range elements. Said input engine may be trained on said information to improve future cyber range generations.

Said cyber range development instructions may be based on Packet Capture (PCAP) data and cyber range documentation.

The method may further include performing, via said input engine, an automated vulnerability assessment. The automated vulnerability assessment can provide a security posture of said cyber range specification.

The method may further include, when said validator determines said validity of the cyber range is not valid, generating, via said input engine, new cyber range development instructions based on additional input from said user.

Further objects, features, and advantages of the present invention over the prior art will become apparent from the detailed description of the drawings which follows, when considered with the attached figures.

### DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a system and associated environment of an embodiment of the present invention;

FIGS. 2A and 2B illustrates a cyber range developer in accordance with an embodiment of the present invention;

FIG. 3 is a flow diagram illustrating an embodiment of a method of the invention;

FIG. 4 is an example interface in accordance with an embodiment of the present invention;

FIG. 5 is an example graph visualization in accordance with an embodiment of the present invention;

FIG. 6 is an example node of the graph of FIG. 5 in accordance with an embodiment of the present invention; and

FIG. 7 is a second example node of the graph of FIG. 5 in accordance with an embodiment of the present invention.

### DETAILED DESCRIPTION OF THE INVENTION

In the following description, numerous specific details are set forth to provide a more thorough description of the present invention. It will be apparent, however, to one skilled in the art, that the present invention may be practiced without these specific details. In other instances, well-known features have not been described in detail so as not to obscure the invention.

Aspects of the invention comprise methods, devices and systems for generating a cyber range using a generative model.

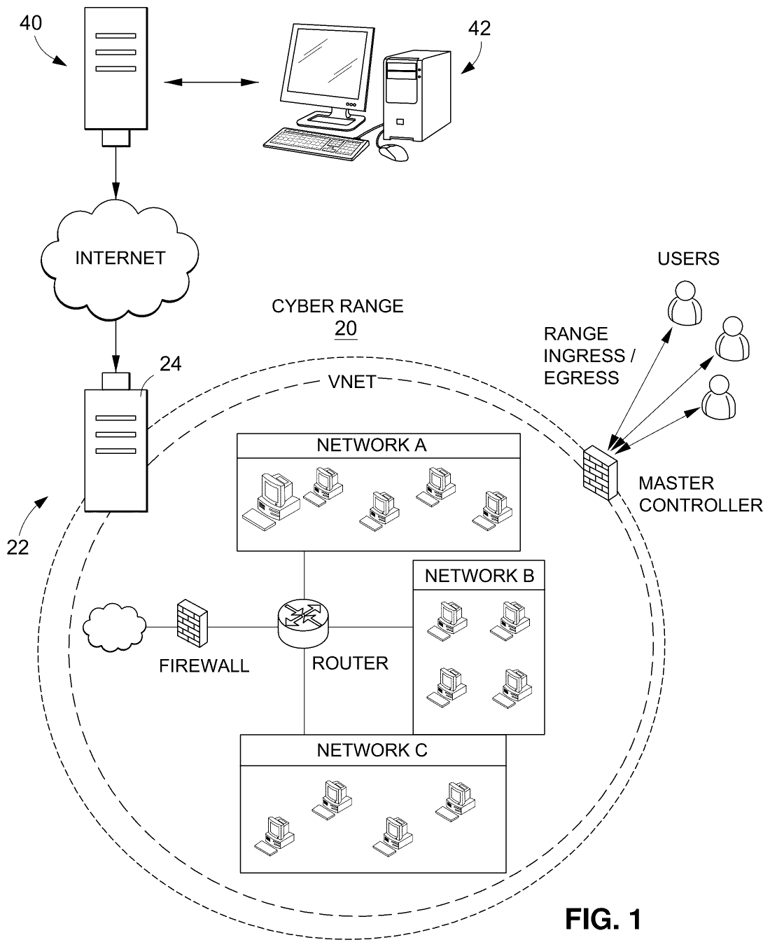

One aspect of the invention will be described with reference to FIG. 1. As illustrated therein, a cyber range 20 may be implemented by a cyber range system 22. The cyber range system 22 may comprise a cyber range server 24 and/or other devices. For example, the cyber range server 24 may comprise a processor, a memory, machine-readable code (e.g. software) stored in the memory and executable by the processor to cause the processor to implement the desired functionality, one or more communication interfaces, and/or other elements.

As illustrated, the software of the cyber range server 24, such as a range orchestrator, may be configured to receive cyber range specifications which are used to create or implement the cyber range 20. Such a cyber range 20 may, as illustrated in FIG. 1, define a plurality of virtual computing elements such as virtual computing devices (work stations, servers, etc.), networks, communication links and communication equipment (routers, switches, etc.) and associated software (operating systems, applications, etc.), where the cyber range virtually mimics a physical computing environment.

In one embodiment, the cyber range system 22, such as the server 24, may implement a master controller which controls ingress/egress of the users of the cyber range 20 (such as via communicatively coupling a computing device of the user to the cyber range server 24) and the cyber range 20 created thereby, whereby user inputs may be made that are implemented relative to the cyber range 20, and whereby changes to the cyber range 20 (such as by the user, an opponent, the system, etc.) may be provided to the user.

It will be appreciated that the cyber range 20 may be private (such as implemented relative to one or more devices to which user access is limited, such as by a server of a particular company as associated with a LAN thereof which allows only employees of the company to access and use the cyber range) or public, such as where public users (who have permission) may access the cyber range, such as via the Internet to a cyber range that is implemented by one or more cloud servers. Of course, various configurations of cyber range systems that are now known or are later developed may have applicability to the present invention.

One aspect of the invention is a system for generating cyber range specifications for deployment by the cyber range system or cloud orchestration tooling like HashiCorp's Terraform. This system may comprise one or more computing devices. In one embodiment, a cyber range developer may be implemented by one or more computing devices, such as a cyber range developer server 40. Such a server 40 may comprise a processor, a memory, machine-readable code (e.g. software) stored in the memory and executable by the processor to cause the processor to implemented desired functionality, one or more communication interfaces, and/or other elements.

In some embodiments, it will be appreciated that the same computing equipment that is used to generate, implement, and/or design the cyber range may also be used to develop, deploy, and/or orchestrate the cyber range. For example, a single server might be configured (such as via software executed by the processor thereof) to both develop a cyber range and then deploy or implement that cyber range.

In one embodiment, one or more user interface devices 42 may interface with the developer server 40. The user interface device 42 may comprise a computing device such as a workstation, laptop, tablet, PDA, etc., such as having a processor, a memory, machine-readable code stored in the memory and executable by the processor, one or more user input devices (such as, but not limited to a keyboard, touch-screen, mouse, etc.) and one or more user output devices, such as a video display. The user interface device 42 is preferably capable of communicating with the cyber range developer server 42, such as via a communication interface of the user interface device 42 and a communication link to the communication interface of the cyber range developer server 40.

In one embodiment, the cyber range development system (such as via the developer server 40) is configured to generate specifications for a cyber range which may be used to implement the cyber range, such as via a cyber range system 22.

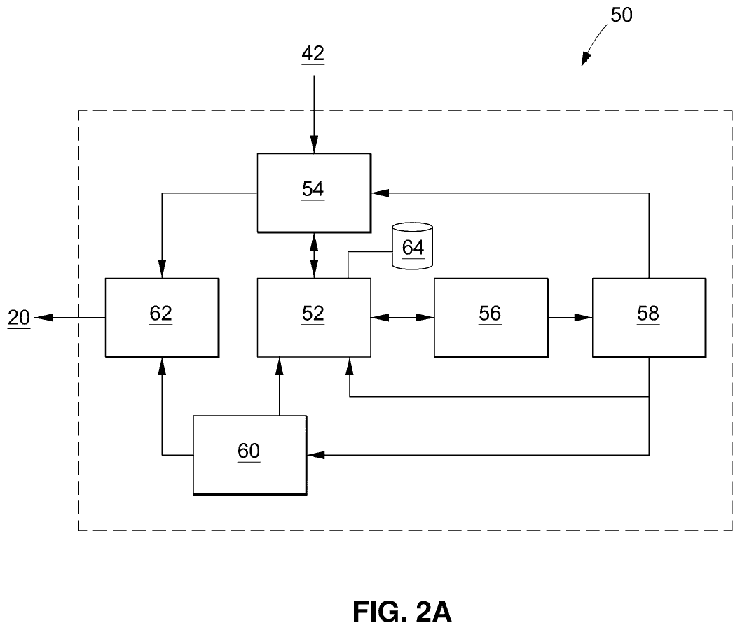

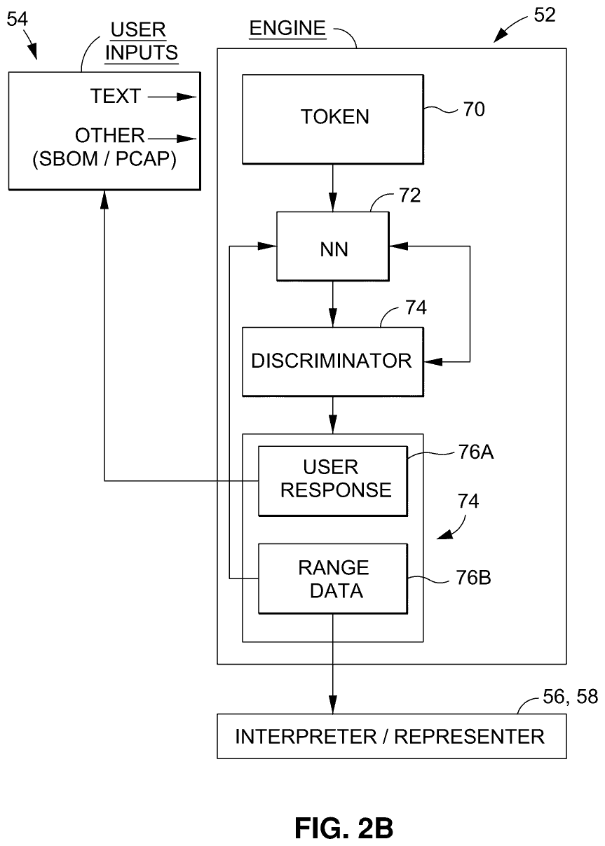

One embodiment of a configuration of a cyber range developer 50 is illustrated in FIG. 2A, and maybe be implemented by software executed by the processor of the developer server 40 (or might be implemented via hardware, and might be implemented by multiple devices which are communicatively coupled). In one embodiment, the developer 50 has a plurality of elements. The elements may comprise part of the same implementation (such as executable software module) or be implemented as different elements, such as different software modules.

In one embodiment, the developer 50 comprises an input engine 52, a user interface 54, an interpreter 56, a representer 58, a validator 60 and an exporter 62.

Most importantly, the input engine 52 is configured to receive user inputs, process those user inputs, and generate one or more outputs. In one embodiment, the engine interprets user inputs, with two concurrent functions: (1) Human-facing: answering questions and providing semantic descriptions of changes to the range design; and (2) Internal-facing: producing computer-interpretable instructions for creating and modifying cyber range specifications based upon the user inputs.

In a preferred embodiment, the engine 52 is configured to implement (directly or via interfacing to another engine) a cyber range generative model. In one embodiment, this model may comprise or include a large language model (LLM) conversational interface. For example, the engine 52 may interface with a database 64 which stores a large language model dataset for use by the engine 52, and or other information, such as stored tokens or other modeling data as described below.

In general, the engine 52 is configured to generate a conversational interface (audible or written) with a user, where the conversational interface may generate user prompts (such as instructions or questions), receive user inputs (preferably in language format), interpret received user inputs, and can generate responses back to the user. In one embodiment, the conversational interface may be configured to leverage one or more models or data structures and utilize the LLM to interpret user responses and generate user responses within that structure (for example, where the model or structure generates one or more defined instructions or questions for the user, it may receive responses to those particular questions and be configured to generate a defined range of responses to user inputs based upon the LLM such as editing the design or asking for clarification). The LLM may be a type of artificial intelligence system that uses neural networks, such a neural network with a transformer architecture. The LLM may tokenize the user inputs to create tokens that can be processed through the LLM's neural network. The LLM may then generate responses to the user input. The LLM may optionally use a feature engineering module to transform the raw data into relevant information for use by the LLM, which can improve the performance and accuracy of the LLM.

In some cases, such as where the user is inexperienced in describing the details of a cyber range or where the size or complexity of the range makes it difficult to textually describe the range, the engine 52 can utilize an iterative process to determine the criteria for the cyber range. For example, the conversational interface may work with a user to develop a detailed description of the cyber range purposes, intended audience, and intended use cases for the cyber range (e.g., via question-and-answer interactions with the user). Based on the user responses, the engine 52 can then use the responses as context for working with the user to describe the topology and major components or networks that will exist within the range. In this way, the engine 52 gives the user a mechanism to conversationally specify what is in each individual major component (e.g., sub-network within the range) and how its elements are configured, using the context as previously described.

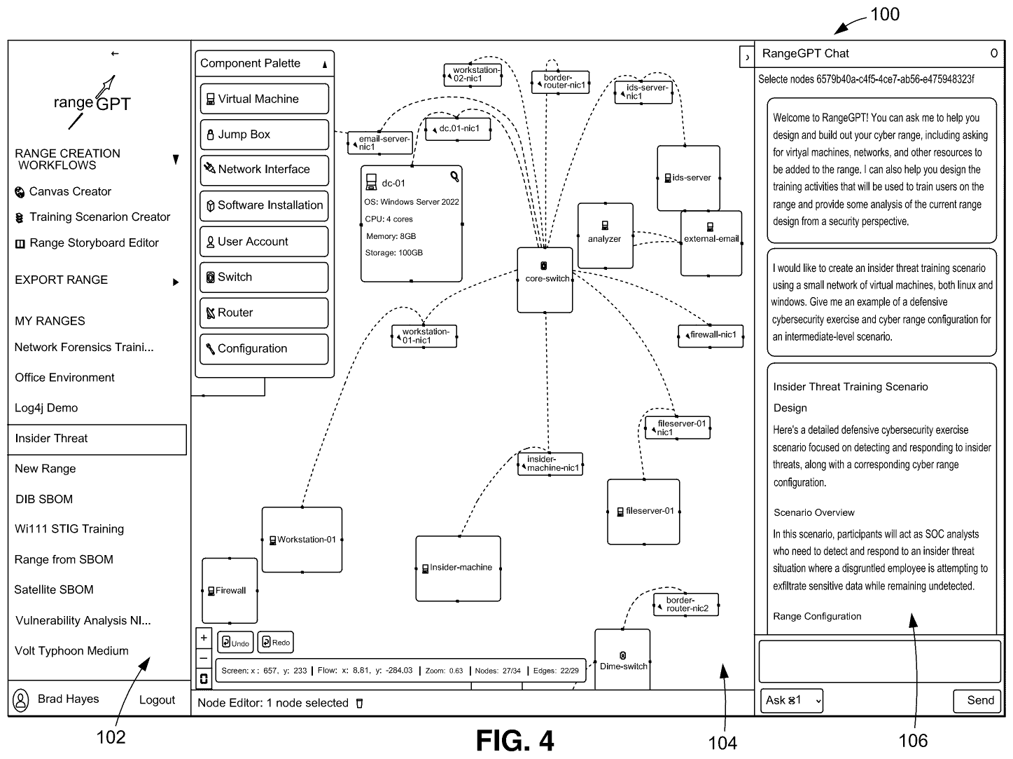

In one embodiment, the engine 52 may utilize an “Attention Mechanism” to identify subgraphs within the overall cyber range graph definition that are relevant to the user's current request. For example, the “Attention Mechanism” may be utilized when the cyber range graph is too large to fit within a single LLM prompt, which may overcome context window limitations for larger ranges. For example, the engine 52 may utilize context inputs to generate a working overview graph of the range, and then use such a mechanism (such as by enlarging a portion of the overview graph) to focus the user on a particular aspect of the range in development for further refinement by additional user inputs. In one aspect, the engine 52 can transform non-graphical user inputs regarding range specifications (such as information regarding characteristics or features of the desired cyber range, including elements thereof) into a graphically represented range (shown in FIGS. 4-7). In this case, the graphically represented range can include both graphically represented range elements, their associated characteristics and/or specifications, and interconnected relationship between the elements (shown in FIGS. 4-7).

As indicated, the engine 52 is configured to receive user inputs and output generated information to a user, such as via the user interface 54. In one embodiment, the user interface 54 comprises an interface to the user, such as the user's interface device 42. The user interface 54 is preferably configured to receive inputs from a user and to transmit generated information to the user. The user interface 54 may, for example, transmit user inputs to the engine 52 and transmit outputs of the engine 52 to the user interface 54.

In one embodiment, the input engine 52 is configured to utilize user inputs to generate range development instructions. The generated cyber range development instructions may be outputted to the interpreter 56, which interprets or translates large language model internal-facing cyber range development outputs into information (such as cyber range data) which can be used by a representer (described below) for generating and/or modifying a graphical range representation.

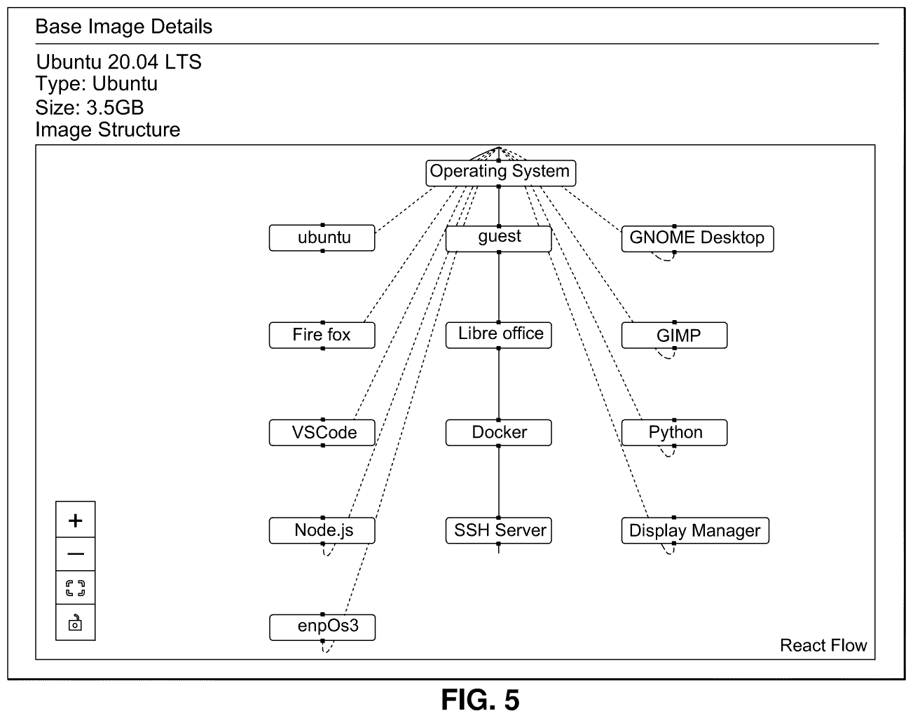

In one embodiment, the generative model, as implemented by the engine 52, may generate range development instructions from other types of inputs aside from and/or in addition to user textual instructions. For example, the engine 52 may generate range development instructions from Packet Capture (PCAP) data. For example, if a user recorded network traffic (e.g., packet capture), this data could be used to generate range development instructions. In another example, the engine 52 may perform cyber range design estimation from a Software Bill of Materials (SBOM) document. For example, the user may prompt the engine 52 with its SBOM, such as “This is my bill of materials (design doc), build me a range.” Likewise, the engine 52 might use a combination of inputs, such as textual inputs and such external data, such as PCAP or SBOM data in combination textual inputs. In another aspect, user inputs may also be reflected as transformations to the graphical range representation (shown in FIGS. 5-7).

In one embodiment, the engine 52 may perform an automated vulnerability assessment, which may provide a security posture of the cyber range design. For example, the engine 52 may perform the automated vulnerability assessment using an LLM. The engine 52 may also perform Common Vulnerability and Exposure (CVE) lookup and identify hypothetical kill-chain steps for the given cyber range, for example using the LLM. In some cases, the LLM can ask for open vulnerabilities on designated software from a vulnerability database. In some embodiments, the engine 52 may provide feedback to the user, such as regarding such vulnerabilities, operable limitations or inoperability feedback of a range generated according to user specifications, such as to allow the user to modify the specification to address such issues in a cyber range development feedback loop (such as in relation to step S5 of the flow described below, or otherwise).

FIG. 2A schematically illustrates one example of the engine 52. As illustrated, user inputs, such as chat/text inputs, SBOM or PCAP information, is provided to the engine 52 from the user interface 54. These inputs may be, as described herein, transformed into tokens 70. That tokenized information may be provided to the neural network (NN) 72 for processing in the manner above (to transform the user inputs into one or more outputs). In some embodiments, the generated output(s) may be presented to a discriminator 74 for confirmation of validity. If the outputs appear to be invalid (such as by comparison to other range data such as stored in a reference database, through vulnerability assessment or range validation), then feedback may be provided to the NN 72 to reassess (such as with the feedback) the inputs to generate a new set of outputs. In one embodiment, the NN 72 may generate two sets of outputs 76: a user response 76A and a range data output 78B. The user response 76A may comprise a response to the user, such as in the form of a chat response (described in more detail below, such as where a user provides an initial chat input and the engine 52 analyzes that input and determines that additional information is needed from the user, thus formulating a response to the user seeking that input). The range data output 78B may comprise generate range data which is provided to the interpreter or representer 56/58.

The representer 58 preferably transforms the cyber range data into a graphical representation. The representer 58 may transform the cyber range data from the interpreter 56 into a graph-based data structure that encodes all details about cyber range elements and configurations necessary for deployment. In one embodiment, the graph-based data structure may be usable by the user's interface device 42 (such a browser or other application running thereon, or by the user interface 54 as interfaced to the user's interface device 42) to cause the video display of the user's interface device 42 to display a graphical representation of the cyber range—e.g. a visual representation of the cyber range, including the elements thereof, their relationship to one another, etc., as described in more detail below.

As just one example, the graph-based data structure may define the cyber range in terms of nodes and edges, where each node and edge is annotated with a dictionary of metadata. In this configuration, nodes may be used to represent entities or elements, such as but not limited to: virtual machines, networking equipment, software applications, and user accounts. Edges may be used to represent relationships and dependencies between nodes, such as network connections, software installations, and configuration details for entities like user permissions.

In one embodiment, there may be different node types, such as:

(1) Virtual Machines, wherein a virtual machine may have metadata associated therewith, such as: a) ID: Unique Identifier; b) Name: Human-readable name; c) Base Image: filename of disk image to use as template; d) OS: Operating system and version; e) Resources (such as: i) CPU: Number of vCPUs; ii) Memory: Amount of RAM; and iii) Storage: Disk type and size).

(2) Network Interface (NI), wherein a network interface may have metadata associated therewith, such as pertaining to: a) MAC Address; and b) IP Address.

(3) Software Installation, wherein the software [?? ] may have metadata associated therewith, such as: a) Name; b) Version; c) Configuration Details; and d) Dependencies.

(4) Credentials/User Account, wherein such may have metadata associated therewith, such as: a) Username; b) Password; and c) Permissions (such as roles/access rights).

(5) Network Device, wherein such may have metadata associated therewith, such as: a) ID: Unique Identifier; b) Name: Human-readable name; c) CIDR: Network address range; and d) Type: Network type (LAN, WAN, VLAN, etc.).

In one embodiment, there may be different edge types, such as:

(1) Network Connection (NI<->NI, NI<->Network Device), wherein such may have metadata associated therewith, such as: a) Type: Ethernet, Wi-Fi, etc.; b) Bandwidth Limit; and c) Latency.

(2) Software Installation (SI->VM), wherein such may have metadata associated therewith, such as: a) Installation Path; and b) Installation Priority (such as which determines the order software is installed/loaded onto target virtual devices).

(3) User Account (User->VM), wherein such may have metadata associated therewith, such as: a) Account Type (such as User/Administrator, etc.)

In one embodiment, when an update is made to the cyber range (such as iteratively during the development process, such as by input by the user), the input engine 52 may output updates to the interpreter 56, which in turn provides updates to the representer 58 to update the graphical representation of the cyber range, which graphical updates are reflected on the video display of the user's interface device 42 (e.g., such as the graphical representations shown in FIGS. 4-7).

The validator 58 is preferably configured to determine whether the created cyber range (such as reflected by an output of the interpreter 56, or more preferably the representer 58), encodes a cyber range that is feasible to deploy, with an allowable configuration. The validator 58 may utilize a set of stored data, such as rules, which are applied to the generated cyber range data, to determine whether the generated cyber range has an allowable configuration. The set of stored data may be applied to the generated cyber range data with or without the use of an LLM to determine where each rule may apply

In one embodiment, the validator 58 may be configured to check schema, dependencies, configurations, available virtual device/networking device types, and whether files exist (such as in an artifact repository of past generated ranges (such as in a RangeGPT file repository)) to determine if the range represented in the graph is valid. The validator 58 may also perform a schema validation, such as where for each node and edge, the validator 58 validates whether necessary fields are populated with valid data types. The validator 58 may also perform a dependency check, such as validating whether dependencies are met for each node and edge, and/or a configuration validation, such as validating that each configuration field is of a correct type and set to valid values.

If a generated cyber range is valid, then that generated cyber range may be provided from the validator 60 to an exporter 62. The exporter 62 preferably transforms the graphical range specification into a format that can be used by orchestration software to provision and/or deploy the cyber range, such as orchestration software running on the cyber range server 24.

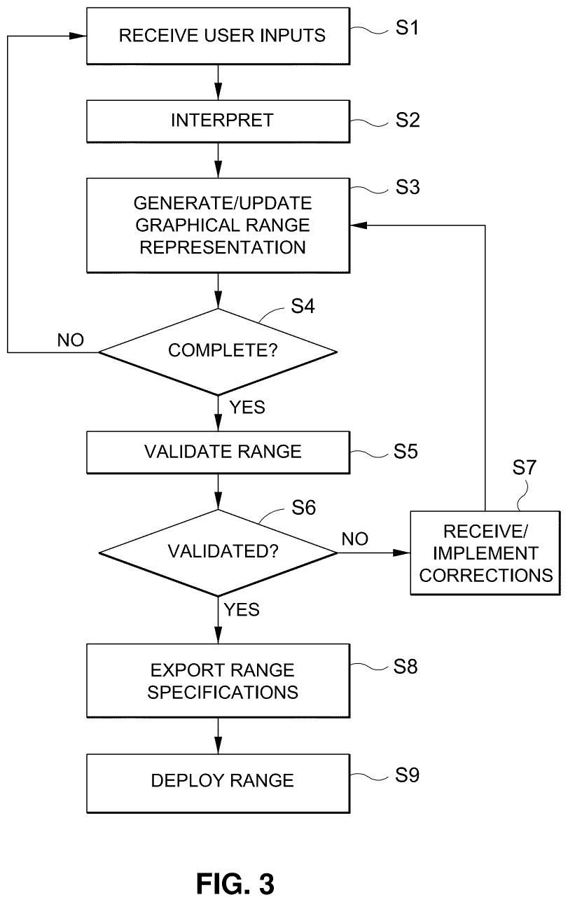

One embodiment of a method of the invention will be described with reference to FIG. 3, wherein in one configuration, the method may be implemented relative to a system such as that illustrated in FIG. 1, including using the cyber range developer 50 described above and illustrated in FIG. 2A.

In one embodiment, in a step S1, a user conversational input is received, such as via voice input to a microphone of the user's interface device 42, by text entry via a keyboard, etc. In some embodiments, the user input may be user-initiated. In others, it might be prompted, such as by instructions or a question presented to the user, such as generated by the engine 52 and transmitted to the user's interface device 42 via the user interface 54. The prompts or questions might be audibly generated, such as output via one or more speakers, or might be displayed to the user in text form, such as on a display of the user's interface device. Inputs may also include PCAP data or SBOM documents as described above.

In a step S2, the user's conversational input is interpreted, such via the input engine 52 and interpreter 56) in the manner described above.

In a step S3, the output of the interpretation of the user's input (such as the output of the interpreter 56) is preferably used to generate or update a graphical range representation, such as by the representer 56 described above.

In a step S4, it is determined whether the range is complete. If not, then steps S1-S3 may be repeated, with the user providing further inputs regarding additional desired aspects for the cyber range.

In a step S5, if the cyber range is complete, then it may be validated, such as via the validator 60 in the manner described above. In a step S6, if the cyber range is not validated, then in a step S7, one or more corrections may be made to the cyber range (such as via the engine 52 or by further input by the user, such as in response to one or more questions or other prompts). If updates are made to the cyber range, then a new graphical representation may be generated, as in step S3, and the process may proceed to step S4 again.

In step S6, if the cyber range is validated, then in step S8, the cyber range may be exported. As indicated above, this may be done by an exporter 62 which is configured to transform a graphical range representation into a designated format for a range orchestrator.

In step S9, the cyber range may then be deployed, such as via a cyber range system 22 which includes a cyber range server 24.

In one embodiment, the cyber range generative model transfer can receive training objectives as part of the cyber range development (such as in the form of textural inputs or defined missions) and may also transfer or apply training objectives from one cyber range to another, which can let organizations “project” established training scenarios onto their own ranges and/or digital twins of their own infrastructure. For example, this would let an end user import a training scenario (e.g. a battle room or mission as described in co-owned U.S. Pat. No. 10,238,948 which is incorporated herein in its entirety by reference) as an input to the engine 52 for implementation relative to a cyber range that represents the user's own infrastructure, rather than a generic infrastructure.

In one embodiment, the systems and methods described herein may include a process to turn a user's LLM conversation and the corresponding range graphs/edits into training tokens for model finetuning. This can make the LLM more effective in responding to user requests for cyber range editing. For example, the system can use the data from the cyber range model, such as conversations with the users, to make the LLM more effective at creating cyber ranges. For example, the system can identify what question/answer pairs were valuable and use them for training tokens or other training methods.

In one embodiment, the systems and methods described herein may include a process to turn the SBOMs, network documentation, and/or network mapper (nmap) scans into training tokens that can help the LLM be more effective in responding to a user's cyber range design requests or questions. In this way, the LLM can be better trained to generate future cyber ranges.

In one embodiment, the systems and methods described herein may include a “Dry Run” workflow and test capability. The system can use symbolic planning techniques over the range design to work through a coarse simulation of the effects of running a piece of malware/software without having to actually deploy the range. As an example, if there is a piece of malware that a user wants to test on a real range, the malware may destroy the equipment. With the “dry run” workflow, the cyber range can operate theoretically without actually damaging the equipment. Instead, the user can see how the malware would behave without destroying equipment. This process, might be implemented, for example, after the range has initially been generated, but before it is formally deployed.

Set forth below are two overview examples of an implementation of the present invention.

### Example 1: Novice User

Scenario: An entry-level cybersecurity trainee tasked with creating a basic cyber range for practicing network security techniques.

### Step-by-Step Interaction:

### Initialization:

User Input: “I need to set up a simple cyber range to practice basic network security.”

RangeGPT: “Sure! Let's start with the basics. How many virtual machines and networks do you need?”

### Virtual Machine Specification:

User Input: “I need three virtual machines: one for a web server, one for a database, and one for a client machine.”

RangeGPT: “Got it. I will create three VMs. Can you provide details like operating systems and resource requirements, or should I use default settings?”

### Resource and Configuration Details:

User Input: “Please use default settings for now.”

RangeGPT: “Okay, I have set up three VMs with default configurations. Next, let's connect them. Do you want them all on the same network?”

### Network Configuration:

User Input: “Yes, connect them on the same LAN.”

RangeGPT: “Done. The VMs are now connected on a local network with a basic router. Do you need any specific software installed on any of these machines?”

### Software Installation:

User Input: “Yes, install a web server on the first VM, a database server on the second, and a web browser on the third.”

RangeGPT: “I have installed Apache on the web server VM, MySQL on the database server VM, and Firefox on the client VM. Anything else?”

### Validation and Deployment:

User Input: “No, that's all for now. Can you check if everything is correctly set up?”

RangeGPT: “Validating the configuration . . . . Everything looks good. Your cyber range is ready to be deployed. Shall I proceed with the deployment?”

User Input: “Yes, please deploy it.”

RangeGPT: “Deploying the cyber range now. You can start using it for your practice by logging in via RDP <details> or SSH <details>. I have saved your range design as basic-network-security.json”

Outcome: The novice user successfully sets up a basic cyber range with minimal technical details, guided by the conversational interface. This allows them to focus on learning and practicing without needing deep technical knowledge to develop the cyber range.

### Example 2: Expert Cybersecurity Professional

Scenario: A senior cybersecurity analyst designing a complex cyber range for simulating advanced persistent threats (APT) and testing incident response strategies.

### Step-by-Step Interaction:

### Initialization:

User Input: “I need to create a complex cyber range for simulating an APT scenario.”

RangeGPT: “Understood. What components and configurations do you have in mind for this simulation?”

### Detailed Specification:

User Input: “I need a network segmented into three subnets: DMZ, internal network, and a secure zone. The DMZ should have two web servers, the internal network should have a mix of 10 workstations and 3 file servers, and the secure zone should have a database cluster of 5 VMs.”

RangeGPT: “Setting up the network segmentation with specified components. Do you have specific operating systems, software, or configurations for these machines?”

### Custom Configurations:

User Input: “Yes. Web servers should run Ubuntu with Nginx, workstations on Windows 10 with endpoint protection software, file servers on Windows Server 2019, and the database cluster on CentOS with PostgreSQL.”

RangeGPT: “Configuring each machine with the specified OS and software. Do you need specific network configurations or security settings?”

### Advanced Network and Security Configurations:

User Input: “Yes. Apply network isolation between subnets with strict firewall rules. Enable logging and monitoring on all machines and set up an intrusion detection system on the internal network.”

RangeGPT: “Configuring network isolation, firewall rules, logging, monitoring, and IDS as specified. Any additional settings or components?”

### Validation and Refinement:

User Input: “Validate the current setup and check for any configuration issues.”

RangeGPT: “Validating . . . . I found a potential issue with the firewall rules between the DMZ and internal network. Do you want to review or fix it?”

User Input: “Show me the details.”

RangeGPT: “Displaying the firewall configuration details . . . ”

User Input: “Fix the issue by allowing specific ports for HTTP and HTTPS traffic.”

RangeGPT: “Issue fixed. Revalidating . . . . All configurations are now valid. Shall I proceed with the deployment?”

### Deployment:

User Input: “Deploy the cyber range.”

RangeGPT: “Deploying the cyber range now. It will be ready shortly for your simulations. You can access it by logging in via RDP <details> or SSH <details>. I have saved your range design as apt-simulation.json”

As indicated above, the cyber range development system 22 may further include a user interface 54. The user interface 54 may comprise a communication link to a user interface device 42 and be configured to both provide information to the user interface device 42 and receive information from the user interface device 42. In one embodiment, the information provided by the user interface 54 may be configured to cause the user interface device 42 to display a graphical user interface 100, one example of which is shown in FIG. 4. In this example, the graphical user interface 100 may comprise a menu 102, a range field or canvas 104 and a chat box 106.

The menu 102 may comprise selectable action elements usable to create/edit a range, export a range and/or select an existing range (for editing or export) or enable other functionality described herein.

As described in more detail below, the range field or canvas 104 may be used to display information regarding a range, such as a graphical representation of a range or a portion thereof, including details of one or more individual components of a range.

The chat box 106 allows a user to interact with the system in order to develop the cyber range, such as by providing inputs to the system 22. The chat box 106 may be implemented by a chat engine of the range developer server 40 and may comprise a large language model (LLM)-driven chat. The LLM-driven chat may be a component of the interface within a more comprehensive drag-and-drop canvas-based user interface that allows for users to manually edit components of their cyber range design or to use the LLM for changes, as described above.

As indicated above, a representer 58 may be configured to transform range specification data into a graphical representation of the range. The output of the representor may be displayed to a user, such as by the graphical user interface 100. For example, as illustrated in FIG. 4, the range field 104 may display a graphical representation of an in-development or completed range (or a portion thereof). This representation may display graphical representations of elements of the cyber range and their relationship, such as nodes and edges of the range. The nodes and edges may be represented by icons which relate to components of the cyber range, graphically displayed connectors or other elements to represent connections or interrelationships of range elements, and by displaying text or other information about the range and its elements. In this manner, a user is provided with a “view” of the range, including its components and their interrelationship.

Moreover, in accordance with the invention, the user can interact with the system 22 to modify the range, such as by input to the chat box 106 and/or interaction with the range field 104.

As one example, the interface 100 may allow users to select elements of the displayed range from the range field or canvas 104 and be provided with more details regarding the selected element. For example, a user might select a particular object, such as an icon or node of the displayed range. As one example, a user may inspect a range object (node/edge, etc.), such as to determine details regarding that object. For example, a user may inspect into disk images that may be used with a virtual machine on the cyber range field or canvas 104, giving insight into its software and default configuration details. These details can be manually annotated (e.g., in a yaml file that accompanies the disk image file) and called up from the associated file for display to the user upon selection of the object, or discovered by an agent that crawls through the image (and/or underlying range data from which the graphical representation is generated) looking for software or configuration details it can recognize. Selecting the node, object or the like, or selecting an icon (such as a magnifying glass on a node or a displayed menu element associated with the node) (e.g., the ubuntu-vm node) brings up the base image details including a graph that depicts pre-installed software, user accounts, or configuration details. Such details may be displayed in a pop-up window or in other manners, such as illustrated in FIG. 5.

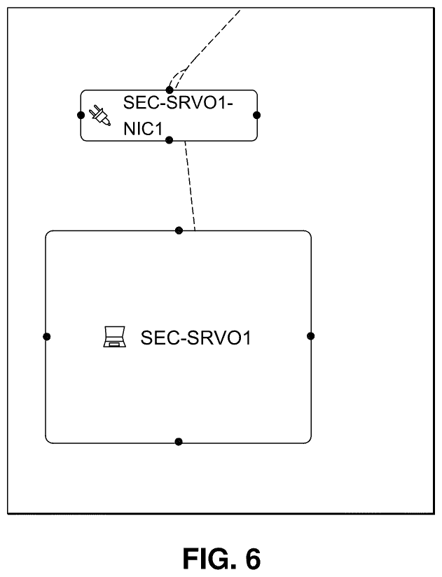

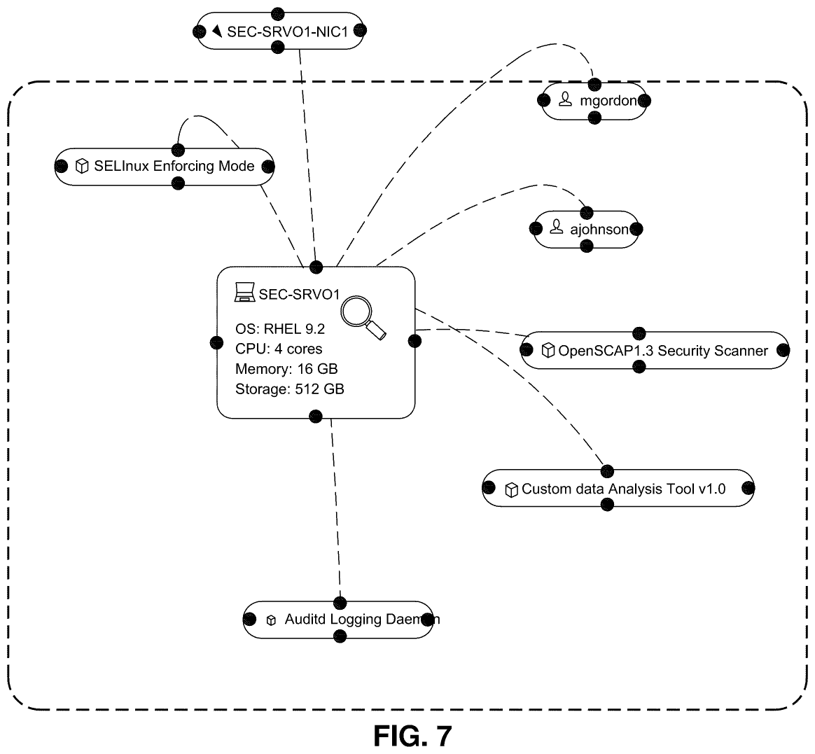

Further, to simplify the presentation of information, the cyber range graph visualization displayed on the field/canvas 104 may allow users to “zoom in” to a portion of the displayed range, such as each node or object (such as the portion of the range shown in FIG. 6) to see additional details of that portion of the range which are not displayed in the larger format of the range (e.g. the details of the elements of the range which are displayed at different levels of “zoom” may vary, wherein additional details of individual elements of the range may be displayed at higher zoom levels). FIG. 7 illustrates another example where a user has zoomed into a virtual machine that is based off of a Red Hat® Enterprise Linux® image. In addition to designing cyber ranges, the LLM is able to guide users through the design of training scenarios that utilize the cyber ranges as their underlying infrastructure. In scenario creation mode for a given cyber range graph, the LLM can help users specify a Scenario Name, Learning Outcomes Description, Narrative/Storyline, and an enumerated set of objectives for the user to complete, assisting with the completion of fields in the scenario builder UI.

The present invention provides methods, devices and systems for cyber range development in a virtual environment using an LLM trained on the user's conversation, the corresponding range graphs/edits, SBOMs, network documentation, and/or network mapper (nmap) scans. Unlike convention systems that require a user to input detailed specifications regarding the desired cyber range and may nevertheless result in a non-functional cyber range, the disclosed invention can transform general user information and requests for a cyber range into a functional cyber range by conversationally extracting information from the user and utilizing other range development instructions and transforming the information into range development instructions. The architecture of the cyber range development system allows for substantially improved accuracy in creating the cyber range and improves implementation speed for creating cyber ranges.

The invention achieves these advantages through a technical solution that synthesizes user input data and stored cyber range information, applies data normalization and feature engineering modules, and trains the LLM using correlated data batches, in one example. The input engine may be implemented on dedicated hardware to maintain improved response times, and integration with an LLM further enables immediate generation of functional cyber ranges, assessment of cyber range vulnerabilities, and identification of kill-chain steps for the given cyber range. This can improve the functioning of the cyber range by quickly creating a functional cyber range and identifying vulnerabilities in the cyber range, illustrating a concrete technical improvement in cyber range systems.

Of course while in certain embodiments machine-readable code may be utilized to implement various features, in some embodiments, the features may be implemented by hardware (such as configured circuits, such as in chip format).

As described herein, communication links may be utilized to exchange information between different devices or systems. Such links may be wired, wireless or combination thereof, include one or more networks such as local area networks (LANs), wide area networks (WANs), the Internet, cellular networks, etc.

As used herein, “implement” may be used in the sense of “design” and “develop” may be used in the sense of “deploy” and/or “orchestrate.”

While in one embodiment, the features of the developer 50 (such as the input engine 52, user interface 54, interpreter 56, representer 58, validator 60 and exporter 62) are described as individual elements, such as may be implemented by different modules of software, it will be appreciated that the features of those elements might be integrated with one another, such as where they are part of a single developer.

The invention has a number of advantages and solves problems associated with existing systems and methods for developing cyber ranges.

As one aspect of the invention, a cyber range is developed from interpretation of conversational inputs or commands from a user. In one embodiment, those inputs or commands do not require a designated format or cybersecurity or cyber range expertise.

As another aspect of the invention, generated cyber range specification data is transformed into a graphical representation of the generated range. This graphical representation comprises a visual representation of the generated range, including the elements of the range and their relationship to one another. The generated graphical representation thus allows a user to see the created range, rather than have to attempt to interpret the configuration of the range from range specifications. The user is able to interact with the graphical representation of the range to obtain additional details regarding the range, including to make modifications thereto. In one embodiment, modifications made to the range specifications are reflected as changes to the graphical representation of the range, preferably in real time or near real time.

As yet another aspect of the invention, a validator uses stored data or runs checks on the generated range in order to validate the operability of the range before it is deployed.

It will be understood that the above-described arrangements of apparatus and the method there from are merely illustrative of applications of the principles of this invention and many other embodiments and modifications may be made without departing from the spirit and scope of the invention as defined in the claims.

What is claimed is:

1. A cyber range development system comprising:
a computing device comprising a processor, a memory, a communication interface, and machine-readable code stored in said memory and executable by said processor to cause said processor to:
implement an input engine, said engine configured to receive inputs regarding a cyber range received from a user via a user interface device to said computing device via said communication interface, and to transform the user inputs into cyber range development instructions;
implement an interpreter configured to transform said cyber range development instructions into cyber range data;
implement a representer, said representer configured to utilize said cyber range data to generate information regarding a graphical representation of the cyber range for use by said user interface device in displaying said graphical representation of said cyber range on a display of said user interface device;
implement a validator configured to determine a validity of the cyber range; and
implement an exporter, said exporter configured to transform said information regarding said graphical representation of said cyber range into a cyber range specification usable by a cyber range orchestrator to implement said generated cyber range.

2. The cyber range development system in accordance with claim 1, wherein said input engine implements a large language model to transform said user inputs into specific cyber range development instructions.

3. The cyber range development system in accordance with claim 2, wherein said large language model utilizes an iterative process of providing follow up questions to said user and receiving responses from said user to said follow up questions to determine criteria for said cyber range.

4. The cyber range development system in accordance with claim 1, wherein said machine-readable code is further configured to cause said processor to implement a user interface between said input engine and said user interface device and said representer and said user interface device.

5. The cyber range development system in accordance with claim 1, wherein said information regarding said graphical representation comprises information regarding a plurality of nodes and edges.

6. The cyber range development system in accordance with claim 1, wherein said graphical representation comprises information regarding graphically represented range elements, one or more associated characteristics and specifications of said range elements, and a plurality of interconnected relationships between said range elements.

7. The cyber range development system in accordance with claim 1, wherein said input engine is trained on said information to improve future cyber range generations.

8. The cyber range development system in accordance with claim 1, wherein said cyber range development instructions are based on Packet Capture (PCAP) data and cyber range documentation.

9. The cyber range development system in accordance with claim 1, wherein said input engine is further configured to perform an automated vulnerability assessment, said automated vulnerability assessment providing a security posture of said cyber range specification.

10. The cyber range development system in accordance with claim 1, wherein when said validator determines said validity of the cyber range is not valid, said input engine is further configured to generate new cyber range development instructions based on additional input from said user.

11. A method for developing a cyber range system, comprising:
receiving, via an input engine, inputs regarding a cyber range received from a user via a user interface device to a computing device via a communication interface;
transforming, via said input engine, said user inputs into cyber range development instructions;
transforming, via an interpreter, said cyber range development instructions into cyber range data;
utilizing, via a representer, said cyber range data to generate information regarding a graphical representation of the cyber range for use by said user interface device in displaying said graphical representation of said cyber range on a display of said user interface device;
determining, via a validator, a validity of the cyber range; and
transforming, via an exporter, said information regarding said graphical representation of said cyber range into a cyber range specification usable by a cyber range orchestrator to implement said generated cyber range.

12. The method in accordance with claim 11, wherein said input engine implements a large language model to transform said user inputs into specific cyber range development instructions.

13. The method in accordance with claim 12, wherein said large language model utilizes an iterative process of providing follow up questions to said user and receiving responses from said user to said follow up questions to determine criteria for said cyber range.

14. The method in accordance with claim 11, further comprising:
implementing a user interface between said input engine and said user interface device and said representer and said user interface device.

15. The method in accordance with claim 11, wherein said information regarding said graphical representation comprises information regarding a plurality of nodes and edges.

16. The method in accordance with claim 11, wherein said graphical representation comprises information regarding graphically represented range elements, one or more associated characteristics and specifications of said range elements, and a plurality of interconnected relationships between said range elements.

17. The method in accordance with claim 11, wherein said input engine is trained on said information to improve future cyber range generations.

18. The method in accordance with claim 11, wherein said cyber range development instructions are based on Packet Capture (PCAP) data and cyber range documentation.

19. The method in accordance with claim 11, further comprising:
performing, via said input engine, an automated vulnerability assessment, said automated vulnerability assessment providing a security posture of said cyber range specification.

20. The method in accordance with claim 11, further comprising:
when said validator determines said validity of the cyber range is not valid, generating, via said input engine, new cyber range development instructions based on additional input from said user.
